(19) United States
(12) Patent Application Publication
(10) Pub. No.: US 2005/0238746 A1
(43) Pub. Date: Oct. 27, 2005

(54) Apparatus, system and method for making hydrogel particles

(75) Inventors: Kevin Crather, Warwick, MD (US); Robert DiCosimo, Rockland, DE (US); F. Glenn Gallagher, Wilmington, DE (US); Susan Marie Hennessey, Avondale, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(73) Assignee: E.I. DuPont De Nemours & Company

(21) Appl. No.: 10/643,254

(22) Filed: Aug. 18, 2003

Related U.S. Application Data
(60) Provisional application No. 60/437,307, filed on Dec. 31, 2002.

(51) Int. Cl. B29C 59/00

(52) U.S. Cl. 425/67; 425/313

(57) ABSTRACT

Disclosed is an apparatus, system and method for producing uniform hydrogel particles. The system of the invention contains a feed station, a metering device, a novel hydrogel particle-forming apparatus and a quench station.

### FIELD OF THE INVENTION

The present invention relates to a particle-forming apparatus, system and method that enable uniform mass hydrogel particle formation by controlling the volume of hydrogel in the particle.

### BACKGROUND OF THE INVENTION

Hydrogel particles are commonly used as support materials for chromatographic processes and for immobilizing microbial cells for fermentation or catalytic applications. Hydrogel particles are also commonly referred to as hydrogel “beads”.

Immobilizing microbial cells, a type of biomass, in hydrogels has the advantages of enhancing microbial cell enzyme stability, allowing biomass reuse, increasing the effective reactor volume, and allowing continued process operation and/or simplification of biomass-liquid separations. Immobilizing biomass is particularly useful for continuous fermentation where the biomass is retained in the reactor when the clarified broth is continuously or semi-continuously removed. It is also useful for enzymatic reactions where the enzyme or microbial cell is retained in the hydrogel while the reactant and product are in the surrounding liquid.

Uniformly sized and shaped hydrogel particles or beads are desired in order to simplify production protocol, and improve cost-effectiveness for industrial applications.

Traditional hydrogel particle-forming techniques use the solution-flow characteristics of the hydrogel solution to generate droplets. Additionally, traditional techniques use the solution-flow characteristics of hydrogel/biomass mixtures to generate droplets from a small hole, a liquid stream, or spinning disk. Droplet formation in these methods is influenced by solution characteristics such as viscosity and surface tension. Batch variations in hydrogel quality and in the cell suspension result in variations in droplet form leading to production of non-uniform particles. The skilled artisan must carefully adjust processing conditions and/or solution composition to compensate for these material variations to produce reasonably uniform particles. Without adjustment, particles are formed with tail threads, broad size distribution, or multi-bead strings instead of as discrete, uniform, spherical droplets.

In addition to the particle-forming techniques referred to above, various methods are known to physically entrap living cells inside a porous material.

Oliveira et al. (J. of Applied Polymer Science, 60:63-73 (1996)) disclose preparation of hydrogels in bead form by dropwise addition of cellulose solutions in N,N-dimethylacetamide (DMAc) and lithium chloride (LiCl) to methanol or isopropanol. Discussed are parameters important for efficient droplet formation, which include viscosity, surface tension, and shear forces applied to the biocatalyst and hydrogel solution mixture stream.

Brandenberger et al (Biotechnol. Prog. 15:366-372 (1999)) disclose use of monodispersed beads of calcium alginate for cell immobilization. This method is based on the laminar jet break-up technique whose product strongly depends on the shape and the size of the cells.

Hu et al. (Biotechnol. Prog. 13:60-70 (1997)) screened various materials, including alginate, polyacrylamide, polysulfone, and polyurethane as immobilization matrices of P. aeruginosa CSU-lyophilized biomass powder to remove uranium from wastewater. Their process involves producing P. aeruginosa CSU-polyurethane hydrogel particles with improved droplet generation efficiency by using a rotating nozzle on top of an oil column. The process requires the use of acetone as an inert dilution and/or viscosity-reducing reagent.

Tramper et al. (J. Dep. Food Sci., Agric. Univ., Wageningen, Neth. Trends Biotechnol. 3(2): 45-50 (1985)) describe immobilizing biocatalyst for use in syntheses. The authors demonstrate alginate operation only at room temperature and with a single needle operation.

Prube et al. (Biotechnology Techniques, 12 2:105-108 (1998)) developed a jet-cutting method as an encapsulation/immobilization technique to produce spherical beads. The volume of the beads is influenced by solution properties as the cutting tool strikes unsupported fluid.

Seifert et al. (Biotechnol. Prog. 13:562-568 (1997)) describe drop-forming techniques to produce small, monodispersed alginate beads for cell immobilization. They use a conventional drip method, gas shear, and vibration with a capillary jet breakup technique, all methods influenced by hydrogel/biocatatyst properties.

U.S. Pat. No. 4,639,423 (Kahlert et al.) describes an apparatus for producing biocatalyst beads using a shear drop formation method that is influenced by hydrogel/biomass mixture properties.

German Patent DD 253 244 A1 describes a continuous hydrogel quench system having an inclined surface for isolation of particles wherein the quench fluid is recycled by using an oil/water particle forming technique. The reference is hereby incorporated by reference for its discussion of separation of the formed particles and recycling of the quench fluid back into the system.

All of the above bead-making techniques rely on the properties of the hydrogel/biocatalyst mixture to define the bead size. Furthermore, many of the techniques were demonstrated only on a laboratory scale and are not easily scaled up to larger scale production.

It is believed that no bead-forming technology exists wherein the particle size is controlled in a way that is independent of the properties of the hydrogel/biomass mixture.

There exists a need for a system for producing homogeneous, uniformly sized and shaped particles that is independent of hydrogel/biocatalyst mixture properties. Furthermore, there is a need for a system that is independent of batch variations in hydrogel properties and could be applied to any biocatalyst such as microbial cell suspensions, extracts, or enzymes with any viscosity or surface tension to form discrete, homogeneous particles. Additionally, there is a need for a process and apparatus that enable the production of hydrogel particles with uniform physical properties at high rates of productivity (wt. beads/orifice/unit time).

### SUMMARY OF THE INVENTION

The invention relates to an improved hydrogel particle-forming apparatus [1] comprising:
(a) a housing [2] having a housing wall [3] and at least a first housing cavity [5],
(b) at least one inlet port [4] in the housing wall [3] for introducing hydrogel-forming suspension into the housing cavity [5],
(c) an extrusion die [6] having a face [10] with one or a plurality of extrusion holes [7] through which the hydrogel-forming suspension is extruded from the housing cavity [5],
(d) a cutting assembly [8] comprising at least one cutting blade [9] that cuts the hydrogel particle-forming suspension into individual hydrogel particles when the suspension exits the extrusion holes [7] as the cutting blade [9] moves across each extrusion hole [7], wherein the cutting blade [9] is in close proximity with the face of the extrusion die [10] and moves in a linear, rotating, or reciprocating manner,
(e) optionally, a drive shaft [31] contained within the housing cavity [5],
(f) optionally, one or a plurality of bearings [32] within the housing cavity [5] supporting the drive shaft [31],
(g) optionally, one or a plurality of seals [33] contacting the drive shaft [31],
(h) optionally a mixing device [34] within the housing cavity [5] for mixing the hydrogel-forming suspension,
(i) optionally, one or a plurality of radial slots [35] in the housing cavity [5] for distributing the hydrogel-forming suspension, and
(j) optionally, an internal pump [39] within the housing cavity [5] for moving the hydrogel-forming suspension to the extrusion die [6].

The invention also relates to a hydrogel particle-forming system [20] comprising:
(a) at least one feed station [21] for containing a hydrogel-forming suspension,
(b) the hydrogel particle-forming apparatus [1] as described above,
(c) a metering device [22] having transfer lines [37] connected to the feed station [21] and to the hydrogel particle-forming apparatus [1] for receiving hydrogel-forming suspension from the feed station [21] and delivering it to the hydrogel particle-forming apparatus, [1] and
(d) a quench station [23] containing a quench fluid, wherein the hydrogel particle-forming apparatus [1] is at least partially submerged in the quench fluid and the hydrogel-forming suspension is extruded into the quench fluid from the hydrogel particle-forming apparatus to form hydrogel particles.

Also claimed is a method for producing hydrogel particles, the method comprising the sequential steps of:
(a) providing at least a first feed station [21] containing a hydrogel-forming suspension,
(b) metering the hydrogel-forming suspension by a metering device [22] having transfer lines [37] connected to the feed station [21] and receiving hydrogel material therefrom into the hydrogel particle-forming apparatus [1] as described above, the apparatus [1] being at least partially submerged in a quench fluid;
(c) extruding the hydrogel-forming suspension through the hydrogel particle-forming apparatus [1] into the quench fluid; and
(d) cutting the extruded hydrogel-forming suspension with the blades [9] of the cutting assembly [8] into individual hydrogel particles when the extruded hydrogel-forming suspension exits the extrusion holes [7] of the hydrogel particle-forming apparatus as the blades [9] move across the extrusion holes [7].

### BRIEF DESCRIPTION OF THE DRAWINGS

FIG. 1 is a schematic diagram of the longitudinal section of one embodiment of the hydrogel particle-forming apparatus of the invention.

FIG. 2 is a schematic diagram of the longitudinal section of another embodiment of the hydrogel particle-forming apparatus of the invention.

FIG. 3 is a schematic diagram of the hydrogel particle-forming system of the invention.

### DETAILED DESCRIPTION OF THE INVENTION

The present invention provides a novel apparatus, system and method for making uniform, homogeneous hydrogel particles for chromatographic, fermentation or biocatalyst applications.

The hydrogel particle-forming apparatus [1] of the present invention includes 1) a housing [2] having a housing wall [3] with one or a plurality of inlet ports [4] and a housing cavity [5], 2) an extrusion die [6] containing one or a plurality of extrusion holes [7], and 3) a cutting assembly [8] having one or a plurality of cutting blades [9].

The present invention also provides an improved hydrogel particle-forming system [20] which is an apparatus comprising 1) a feed station [21] to supply the hydrogel-forming suspension, 2) a metering device [22], 3) the hydrogel particle-forming apparatus of the invention [1], and 4) a quench station [23] containing quench fluid such that the extrusion die portion of the particle-forming apparatus [1] is at least partially submerged below the quench fluid at all times.

The invention generates uniform particles through volumetric displacement of the hydrogel-forming suspension and by controlling the volume of the hydrogel in the particles. The present invention does not rely on the properties of the hydrogel/biocatalyst mixture to define the hydrogel particle size. Instead, the particle size of the hydrogel particles formed herein is determined by cutting a volumetric displacement of an extruded hydrogel-forming suspension in a confined geometry. As a result, the method is less susceptible to raw material batch variations. Furthermore, the system of the present invention will enable more cost-effective production of catalyst hydrogel particles for industrial processes. Additionally, the novel apparatus, system and method of the present invention make possible the production of hydrogel particles with uniform physical properties at high rates of productivity (wt. beads/orifice/unit time).

The sizes and shapes of particles produced herein are defined by volumetric flow rate and cutting speed and are independent of hydrogel/biocatalyst mixture properties. The resulting immobilized biocatalyst particles may then be used in various processes to produce a particular desired end product.

Persons skilled in the art will recognize that any processes, reaction or series of reactions that depend on uniform hydrogel particles and the immobilization of microbial cells, permeabilized microbial cells, enzymes, or the like, may benefit from using the system of the present invention.

Accordingly, the present invention is not limited to the particular cell suspension or fermentation batch or a cell suspension with a particular viscosity but may be applied to any biocatalyst that may have improved value when entrapped in a hydrogel particle. One particularly useful application of this invention is the production of enzyme catalysts.

In the present invention, the hydrogel-forming suspension exiting the die has a very low viscosity compared to thermoplastic polymers. An artisan familiar with underwater pelletizing of thermoplastic polyesters would not be familiar with pelletizing such a low viscosity fluid. The high-shear turbulent quench fluid strategy necessary for thermoplastic polymer processing can not be applied to hydrogel particle formation. To address the particle breakup problem associated with high shear quench fluid mixing, the present invention uses an underwater particle-forming method to achieve a quench of the hydrogel polymer at a shear rate consistent with the quench rate for the hydrogel/biocatalyst system and the mechanical strength of the resulting gel to produce uniform, homogeneous particles.

In this disclosure, a number of terms and abbreviations are used. The following definitions are provided for understanding the scope and practice of the present inventions.

The term “hydrogel-particle forming apparatus” as used herein refers to the apparatus of the invention comprising a housing [2], an extrusion die [6] and a cutting assembly [8].

The term “hydrogel-particle forming system” as used herein refers to an apparatus comprising a feed tank [21], a metering device [22], the hydrogel-particle forming apparatus [1], and a quench station [23].

The term “free cells” refers to cells that are not immobilized.

The term “biocatalyst” refers to whole cell suspensions, bacterial cells, fungi, algae, yeast cells, plant cells, animal cells, cellular organelles, or purified or partially-purified enzyme preparations or multienzyme complexes in an appropriate buffer solution. Biocatalyst may contain viable or nonviable cells. The cells may be growing or resting cells. The terms “biocatalyst” and “biomass” will be used interchangeably.

The term “biocatalyst bead” refers to a hydrogel particle containing a biocatalyst (or components of a biocatalyst) in such a way that the enzymes are available to catalyze a reaction either as a single enzyme, a combination of enzymes, or as a viable microbial cell.

The term “hydrogel solution” refers to a polymer solution or mixture of polymers or polymer-forming monomers that form a gel as a result of a quenching operation. Hydrogel solutions useful in the present invention include, but are not limited to, viscous polyelectrolyte solutions (e.g., carrageenan, alginate, cellulose sulfate, pectinate, furcellarane, chitosan), polymer solutions capable of gelling (e.g., agarose, agar, gelatin, curdlan), and non-aqueous polymer solutions (e.g., cellulose acetate, polyacrylamide, polystyrene, polyurethane, polyvinyl alcohol).

The term “hydrogel particle” refers to a particle resulting when a hydrogel solution is subjected to a quenching operation. The terms “hydrogel particles”, “particle”, and “bead” are used interchangeably.

The term “hydrogel-forming suspension” refers to a mixture of hydrogel solution and, optionally, a biocatalyst. The hydrogel-forming suspension can further comprise quench fluid or other additives as they are added to the hydrogel solution and biocatalyst.

The term “temperature-sensitive hydrogel” refers to a hydrogel solution that forms a gel due to a temperature change and has a measurable gel point where the solution viscosity increases sharply. Carrageenan is an example of such a temperature-sensitive hydrogel.

The term “quenching operation” refers to a method of initiating the gelation of a hydrogel solution. The quenching operation includes, but is not limited to, thermal quench, the presence of appropriate cation(s), the presence of an initiator for gelation or polymerization, or a change in solubility.

The term “quench fluid” refers to a liquid that initiates the gelation of a hydrogel solution. The quench fluid is a fluid at an appropriate temperature and/or containing an appropriate cation(s) or other compounds such that the hydrogel solution will be gelled when exposed to the quench fluid. To select the appropriate quench fluid one needs to consider the specific hydrogel solution of interest and the mechanism of gelation. Specific quench fluids for specific polymer solutions are well known and exemplified in “Immobilization of Enzymes and Cells”, Gordon F. Bickerstaff (editor), “Immobilized Biocatalyst: An Introduction”, Winfried Hartmeier, or “Immobilized Cells: Techniques and Applications,” Indian J Microbiol. 29(2): 83-117 (June 1989).

The term “quenching compound” refers to an ionic or covalent compound present in the quench fluid that interacts with the hydrogel solution to create a hydrogel structure.

The term “particle-forming region” refers to the volume of the quench fluid in proximity to the face of the extrusion die [10] and swept out by the movement of the cutting blade(s) [9]. This region of the quench fluid is located where the hydrogel solution exits the extrusion die [6] and is cut into discrete particles.

The term “volumetric metering device” refers to a volumetric pump or a combination of a pump or other source of pressure with a flow meter (ex. mass, volume, or velocity) and a flow regulating device (i.e. a control valve) such that the volumetric flow of the fluid may be controlled at a desired rate.

The term “cutting assembly” refers to the combination of a propulsion system, which can be either linear, rotating, or reciprocating (meaning a back and forth motion), cutting blade(s) [9], and necessary hardware to keep the blade(s) in direct contact with or very close to the face of the extrusion die [10] in the proximity of the extrusion holes [7].

The term “baffle” refers to an object that remains stationary in a fluid, such as, for example, a container wall, as compared to an “agitator” , which refers to an object that moves through a fluid, such as, for example, a cutting blade.

The term “mixing device” refers to static or mechanically agitated device that improves the quality of mixing in a fluid.

The term “homogeneous particles” refers to the uniformity of particle-to-particle consistency in the mass or volume of the particles.

The term “hydroxyapatite” refers to calcium phosphate hydroxide, which has a formula of (Ca₅(OH)(PO₄)₃).

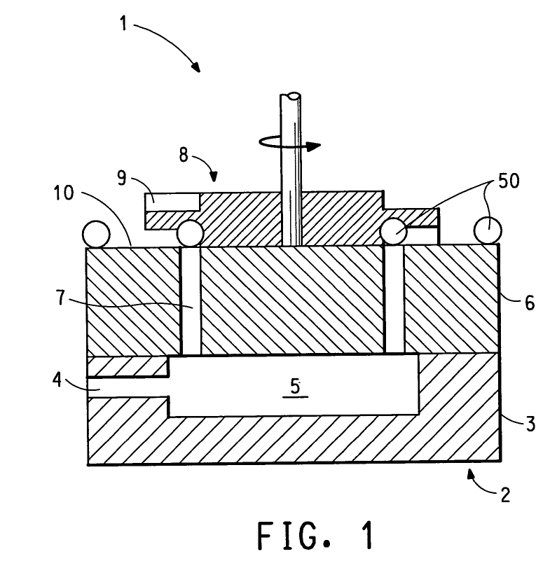

Referring now to FIG. 1, there is shown a longitudinal cross-section of one embodiment of the hydrogel particle-forming apparatus [1] of the invention. The apparatus comprises a housing [2] containing a housing cavity [5] surrounded by a housing wall [3] having one or more inlet or feed ports [4] where one or more streams of hydrogel-forming suspension, quench fluid or other additives enter the apparatus. The apparatus [1] contains an extrusion die [6] having a face [10] with either one or a plurality of extrusion holes [7]. The apparatus further comprises a cutting assembly [8] for cutting the hydrogel-forming suspension into individual particles as the suspension exits the extrusion holes [9]. The cutting blade(s) [9] of the cutting assembly [8] will generally have linear, rotating, or reciprocating movement, but any other movement is operational within the scope of the invention. FIG. 1 illustrates a rotating movement of the cutting blade [9]. The individual hydrogel particles produced [50] are illustrated in FIG. 1.

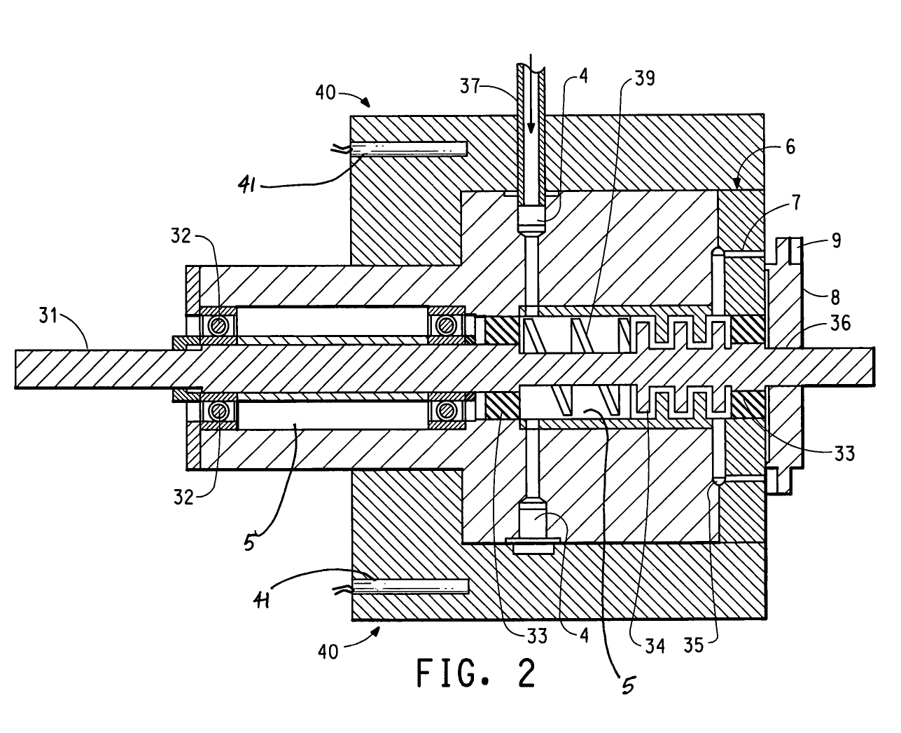

Referring now to FIG. 2, there is shown a schematic diagram of another embodiment of the hydrogel particle-forming apparatus [1] of the invention. The Figure illustrates an optional drive shaft [31] contained within the housing cavity [5]. Optionally, the drive shaft [31] is rotationally mounted. Optionally, one or a plurality of bearings [32] within the housing cavity [5] support the drive shaft [31] in its operation. The apparatus also optionally comprises one or multiple seals [33] around the drive shaft [31] to limit the outward flow of suspension from the housing cavity [5] along the drive shaft [31]. As it enters the housing cavity [5] through the inlet ports [4], the hydrogel-forming suspension moves to the extrusion die [6]. Optionally, a mixing device [34] may be included in the housing cavity [5] for mixing the hydrogel-forming suspension. FIG. 2 illustrates a pin mixer as the mixing device [34]. Optionally, the housing cavity [5] further includes radial slots [35] for improved material distribution within the housing cavity [5].

Referring again to FIG. 1, the extrusion die [6] contains one or a number of extrusion holes [7] or orifices through which the hydrogel-forming suspension is extruded. The extrusion holes [7] may be constructed by drilling holes into an end plate. The extrusion holes may be uniformly spaced on the face [10] of the extrusion die or arranged in any geometric configuration. In a preferred embodiment, shown in FIG. 2, the extrusion holes are arranged in a circular array when used with a rotatably mounted cutting assembly [8]. The extrusion holes [7] may have any cross-sectional area but generally have a circular cross-section.

As the hydrogel mixture exits the extrusion holes [7], the hydrogel material is cut by a cutting blade assembly [8]. In this manner, a fixed volume of hydrogel-forming suspension is metered uniformly through the extrusion die [6] so that a fixed volume exits from each nozzle per unit time. The cutting blade assembly [8] may contain one blade or a plurality of blades [9]. In a preferred embodiment, the cutting assembly [8] is rotatably mounted onto the drive shaft [31] as the drive shaft [31] extends through a central opening [36] in the extrusion die [6]. A preferred cutting blade [9] is in the form of a pitched turbine blade. The pitch of the turbine blade is preferably about 45 degrees. The cutting blade(s) [9] are very close to the face of the extrusion die [10] in the proximity of the extrusion holes [7] and move past the holes such that the metered quantity of extruded hydrogel mixture is cut in a confined geometry.

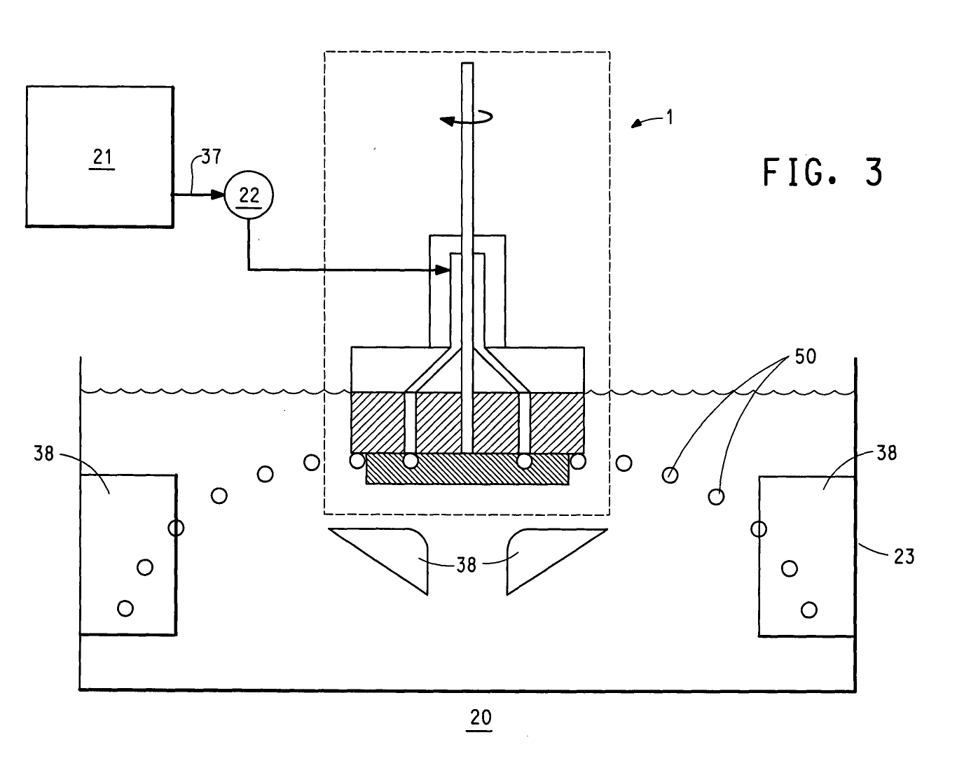

Referring now to FIG. 3, there is shown one embodiment of the hydrogel particle-forming system [20] of the present invention. In a simple form, the system of the invention comprises at least a first feed station [21], which is typically a feed tank, where the hydrogel-forming suspension is combined with water and microbes (or cells) with agitation to form a uniform hydrogel-forming suspension; a metering device [22] where a fixed volume of suspension is metered from the feed station [21] through a transfer line [37] into the inlet ports (not shown) of the particle-forming apparatus of the invention [1]; and a quench station [23] being a reservoir or vessel for containing quench fluid. The particle-forming apparatus [1] is at least partially submerged in the quench fluid so that the hydrogel-forming suspension is extruded and the cutting is performed in the quench fluid. The extruded suspension is in direct contact with the quench fluid, and hence the hydrogel-forming suspension develops a sufficient strength to be cut by the cutting blades [9]. The geometry of the system illustrated in FIG. 3 is particularly well suited for thermal quench hydrogel applications since the hydrogel particle-forming apparatus [1] is only partially submerged in the quench fluid instead of being completely submerged therein.

Optionally, the surface of the face [10] of the extrusion die is treated with a material that has a high contact angle with the hydrogel-forming suspension so that the hydrogel-forming suspension does not wet the surface and clean cuts are therefore achieved. By “contact angle” is meant the angle between a drop of fluid and a solid surface. The movement of the cutting blade [9] circulates the quench fluid and facilitates removal of the freshly cut hydrogel particle(s) [50] from the cutting zone.

In one embodiment of the system, a skilled artisan can additionally introduce quench fluid containing a sufficient amount of quenching compound into the housing cavity [5] separately or with the biocatalyst, the hydrogel solution and/or with other additives in such a way that the viscosity of the hydrogel-forming suspension is increased prior to extruding the hydrogel mixture through the extrusion die [6] in order to reduce elongation of the particles due to viscous drag created by the quench fluid movement, without compromising the quality of the resulting particles. To accomplish this, the system can be designed so that an additional feed station (not shown) to that of feed station [21] on FIG. 3, and metering device (not shown) to that of metering device [22] on FIG. 3 will be added to permit feeding quench fluid into a second inlet port [4] on the hydrogel particle-forming apparatus [1]. The resulting extrudate will have a higher viscosity and will reduce shape sensitivity to circulating quench fluid and permit higher flow rates through the hydrogel particle-forming apparatus [1].

The skilled artisan will recognize that the ratio of feed channels to the die, die holes, cutting blades, as well as the volumetric flow rate per die hole, and cutting speed may be varied as necessary to achieve any desired particle size or production rate from the particle-forming apparatus. The current system is particularly useful when small particles are desirable and the hydrogel fluid characteristics processed through conventional dripping, gas shear or vibrational jet breakup methods yield larger than desired particles. The hydrogel particle-forming system [20] is also useful for viscous hydrogel solutions where the dripping method is not preferred. The maximum production rate per hole must be determined experimentally and will be limited by the interaction of the hydrogel-forming suspension and the quench fluid characteristics at specific conditions and by the viscous drag forces imposed on the forming hydrogel particle by the circulating quench fluid. In further embodiments, the positioning of the particle-forming apparatus [1] in the quench station [23] as well as the addition of auxiliary agitators or baffles [38] to direct the quench fluid can be adjusted to obtain high production rates with minimal particle elongation.

The skilled artisan will recognize that the amount of quench fluid circulated relative to particle formation frequency may be controlled using different cutting blade designs and optional agitators or baffles [38]. Variations include varying the pitch and/or the cross-sectional area of rotating surface, varying the number of blades [9] per number of holes [7], or similar quench fluid mixing and circulation variations. The apparatus [1] can be modified so that the cutting blade assembly [8] regulates the circulation of quench fluid near the particle-forming region. The adjustment changes the intensity of quench fluid mixing near the particle-forming and quenching zone in the quench station [23]. The submerged cutting blade [9] functions as an agitator for the quench fluid while performing the cutting function. A low mixing intensity for quench fluid is preferred for low viscosity hydrogel-forming suspension to minimize viscous drag and elongation of the particles. A high linear velocity of quench fluid past the particle-forming region may be preferred for higher viscosity hydrogel systems where viscous drag on the particles are not a significant concern and higher production rates can be achieved. The specific blade geometry can be carefully adjusted to match specific requirements. The cutting blade assembly [8] and mixing device [34] assembly can be selected from many designs, such as, for example, pitched blade turbine, flat blade turbine, marine-type mixing impeller, and many others. In addition to altering the type of impeller, the pitch and area of the blades [9] may be varied to increase or decrease circulation.

In one embodiment, the feed station [21], the metering device [22], the transfer lines [37] and the hydrogel particle-forming apparatus [1] are heated so that a hydrogel solution with a temperature-sensitive viscosity/gel point (such as carrageenan or agarose) is maintained above the gel point prior to particle formation. The heating can be achieved by, for example, an electrical heating tape, or the entire assembly can be placed in a heated enclosure, which maintains the entire assembly at the desired temperature. Other examples include thermal mass [40] (e.g. alumina, copper, brass) with electrical cartridge heaters [41], traced or jacketed systems where hot fluid (e.g. water, steam, oil) may be circulated, and enclosures with circulating hot gases (e.g. air, nitrogen, helium) or liquids.

In a further embodiment, the housing cavity [5] of the hydrogel particle-forming apparatus [1] incorporates a mixing device [34] to improve homogeneity of the hydrogel and biocatalyst suspension prior to particle formation. The types of mixing devices [34] that can be used in the present invention include, but are not limited to mechanical mixers, (such as a Maddock mixer, a pineapple mixer, a gear mixer, a pin mixer) or static mixers as are commonly known in the art. Further examples of mixers are set forth in Perry's Chemical Engineering Handbook Seventh Edition, R. H. Perry et al. (1997), McGraw Hill. A pin mixer is illustrated in FIG. 2 as the mixing device [34]. In the embodiment of the apparatus illustrated in FIG. 2, a single drive shaft [31] is used to power both the cutting blade assembly [8] and the pin mixer [34]. Similarly, the hydrogel particle-forming system of the invention may also optionally incorporate one or more mixing devices at any point along the process, such as, for example, as described in Example 4. By choice of mixing device, the intensity of mixing can be adjusted to meet specific requirements for the particular hydrogel-forming suspension being processed. A homogeneous hydrogel-forming suspension is obtainable while preventing or promoting cell disruption. As shown in FIG. 2, the hydrogel particle-forming apparatus [1] of the present invention can be modified to include an internal pump [39] such as a centrifugal, screw, or gear pump in the housing cavity [5] to force higher viscosity material into the extrusion holes [7] to permit higher viscosity hydrogel processing.

Operating cost and the tendency for gel formation in the extrusion die [6] due to temperature deviations may be reduced with the use of a thermal insulated die to manage heat losses for temperature-sensitive hydrogel processing. An insulating compound can be used to construct the extrusion die [6] to reduce heat losses to the quench fluid and improve operability of the system for hydrogel solutions that have a temperature-sensitive gel point, such as carrageenan and agarose. The types of insulating materials that can be used in the present invention for thermally insulated extrusion dies [6] include, but are not limited to, thermoplastic or thermoset polymers, mineral and glass reinforced thermoplastic or thermoset polymers, ceramics, foams, minerals, oxides and metals, and other insulating materials generally known to persons skilled in the art.

The system [20] of the invention can further be designed for continuous particle separation and recycling of quench fluid. In such embodiments, the quench station [23] will be modified to permit withdrawal of the quench fluid/particle mixture from the quench station [23] across an inclined surface having small apertures, such as holes, slots, or a screen, so that the quench fluid passes through the inclined surface while the hydrogel particles pass across the top of the incline into a collection container. The quench fluid can then be collected in an additional reservoir and returned into the original quench station for reuse.

In a preferred embodiment, dual mixing feed stations (not shown) and volumetric metering feed systems (not shown) are attached to the housing of the hydrogel particle-forming apparatus so that the hydrogel solution and the biocatalyst may be fed separately, thus minimizing contact time of the microbes or enzymes to the hydrogel solution prior to particle formation.

In another embodiment, the present invention provides a system for binding an enzyme from an external source to free or immobilized microorganisms. The resulting system yields a co-immobilized enzyme/cell system that combines the biocatalytic properties of the microorganism with additional enzyme(s) from another source. In a related embodiment, co-immobilization can also be achieved by immobilizing mixed cultures using the system of the present invention.

One of the benefits that will be clear to persons skilled in the art is that the apparatus, system and method of the invention can be used for small laboratory preparative arrangements as well as scaled up for commercial use to produce uniform hydrogel particles, since the apparatus and system components can be adjusted in size and limited only by a particularly desired application.

The present invention is further illustrated in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### EXAMPLES

### ABBREVIATIONS

The meaning of abbreviations is as follows: “sec” means second(s), “min” means minute(s), “h” means hour(s), “d” means day(s), “μL” means microliter(s), “mL” means milliliter(s), “L” means liter(s), “mM” means millimolar, “M” means molar, “mmol” means millimole(s), “g” means gram(s), “μg” means microgram(s) and “ng” means nanogram(s), mm³” means cubic millimeters, “v:v” means volume per volume, “mPas (cps)” means milli-pascal seconds (the same as centipoise), “dcw” means dry cell weight, “rpm” means revolutions per minute, “psig” means pound per square inch (gauge), “° C.” means degrees Celsius, “cc per minute” means cubic centimeters/minute.

### Example 1

### Controlled Volume Alginate Cutting

A particle-forming system was constructed as in FIG. 3 and used to make hydrogel particles containing microbes with enzyme activity. An 8 L stainless steel feed vessel was equipped with an agitator and connected to a progressive cavity positive displacement pump (Seepex® Pump, Model 003-12 MDC, Seepex Seeberger GmbH & Co., Germany). The output from the pump was connected to in-line filters (NuPro® “F” series containing wire mesh strainer elements at 230 and 140 micron in series, Nuclear Products Company, Willoughby, Ohio) and then to a particle-forming device illustrated in FIG. 2. The particle-forming device was suspended above an 8 L quench fluid container such that the die face was below the surface of the quench fluid.

An alginate solution was prepared by combining 82.5 g of alginate (FMC Protanal® LF10/60, solution viscosity=20-70 mPas (cps) for 1% in water, FMC Biopolymer Corporation, Norway) with 1717 grams of deionized water in the feed vessel and mixed until homogeneous mixture was obtained.

A cell suspension of Acidovorax facilis 72W (American Type Culture Collection 55746) was prepared by combining 918 g of frozen cell paste (24.5% dcw) with 282 g of a 0.65 molar NaCl salt solution in a beaker with a stirring bar and mixed for 60 min until a homogeneous mixture was obtained.

The cell suspension was added to the feed vessel containing the alginate solution and mixed for 30 min until a homogeneous mixture was obtained, then the vessel was pressurized to 10 psig with nitrogen. Valves in the transfer line were opened and the pump was started and set to deliver 113 mL/min of flow. The flow was directed through the particle-forming apparatus using one feed port. The second feed port was not used and was capped off. The speed of the drive shaft was set at 760 rpm. The alginate cell mixture proceeded through a pin mixer and extrusion die containing eight 3/16″ diameter holes. The cutting assembly contained eight blades. The quench fluid used was 0.2 M calcium chloride salt solution.

Knowing that the volume flow per hole was 14.1 mL/hole/min and the cutting speed was 5760 cuts/hole/min; the calculated volume per particle was 2.44 mm³. The resulting particles were collected and the volumes were determined to be 2.08 mm³, 85% of calculated volume. It is known that alginate particles shrink in solutions containing calcium ion. The cutting speed was then maintained at 5760 cuts/hole/min and the volume flow per hole was increased to 22.6 mL/hole/min, increasing the calculated volume per particle to 3.94 mm³. The resulting particles were collected and the volumes were determined to be 3.3 mm³, which is 84% of calculated volume, well within experimental error of expected volume per particle.

### Example 2

### Effect of Increasing Alginate Viscosity

Equipment and procedures were the same as Example 1 except that the alginate used was type FMC Protanal® LF20/40, (FMC Biopolymer Corporation, Norway) an alginate that produces aqueous solutions with higher viscosity than LF10/60 (100-200 mPas for 1% in water). When processed through the particle-forming system, very stable operation was achieved and particle shape was very uniform. Particles with a volume of 2.23 mm³ were produced at a volume flow per hole of 11 mL/min/hole.

An attempt was made to process the same materials through a traditional drop-forming system. The volume flow was limited to no more than 0.1 mL/min/hole to produce drops that were uniform. These particles were 3 mm diameter spheres. This demonstrated the ability of the particle-forming apparatus to make smaller particles from a high viscosity hydrogel-forming suspension than can be achieved with a traditional drop-forming system, and at a considerably greater rate of particle production.

### Example 3

### Operating System at Elevated Temperature with Carrageenan

The particle-forming system described in Example 1 was modified by adding heat exchangers, a second feed tank, a gear pump as the volumetric metering device, and electrical heat tape. The feed tanks, volumetric metering device, static mixer, transfer lines, and particle-forming apparatus were heated so that the hydrogel solution with a temperature-sensitive viscosity/gel point was maintained above the gel point prior to particle formation.

A carrageenan paste was prepared by mixing 150 g of carrageenan (FMC RG300, available from FMC Biopolymer Corporation, Norway) and 2850 g of deionized water in the original feed vessel for 30 min until a homogeneous mixture resulted. The carrageenan paste was heated with mixing to about 80° C. and held for 60 min until the carrageenan was fluid and free of gel. The resulting carrageenan solution was then cooled to 60-65° C.

A cell suspension was prepared by mixing 1270 g of frozen cell paste (22.1% dcw) with 227 mL of a 0.87 M Na₂HPO₄ buffer solution in a beaker with a stirring bar and mixed for 60 min until uniformly mixed. It was then transferred to a second feed vessel (agitated 4 L stainless steel).

The cell suspension was pumped (Seepex® Pump, Model 003-12 MDC, Seepex Seeberger GmbH, Germany) at a volumetric flow rate of 25 mL/min through a heat exchanger which heated the suspension to 50° C. at the outlet. The carrageenan solution was pumped (MicroPump® gear pump, MicroPump, Inc., Vancouver, Wash.) at a temperature of 60-65° C. and a volumetric flow rate of 37 mL/min and combined with the cell suspension in an in-line static mixer (Koch®—SMX, Sulzer Chemtech Winterthur, Switzerland). The flow exiting the static mixer was directed through the particle-forming apparatus using one feed port. The second feed port was not used and was capped off. The speed of the drive shaft was set at 180 rpms. The carrageenan/cell suspension proceeded through a pin mixer and extrusion die containing eight 3/16-inch holes. The cutting assembly contained eight blades. The quench fluid used for this experiment was 0.25 molar KHCO₃ salt solution.

The working volume of the particle-forming apparatus (18 ml), together with the mass flow of the carrageenan/biocatalyst mixture, resulted in a mean cell residence time in the particle-forming device under 20 sec. Combined with the residence time in the cell solution heat exchanger, the static mixer, and the transfer line, the cells were subjected to elevated temperature for less than or equal to 2 min. In addition to maintaining the hydrogel solution well above the gel temperature during storage and metering, premature gellation due to equipment cold spots was avoided.

At the selected operating conditions, the resulting particles were elongated by viscous drag of the quench fluid circulation flow.

### Example 4

### Continuous Flow Heat Up/Cool Down Carrageean in Pipe to Simplify Carrageenan Solution Preparation Requirements

This Example is similar to Example 3 except that the static mixer will be eliminated and both feed ports on the particle-forming device will be used so that the two fluids are mixed in the pin mixer of the particle-forming apparatus device. In addition, the carrageenan paste will be held at room temperature and pumped with a positive displacement pump through heat exchangers to raise the temperature to 80° C., held at 80° C. for a sufficient time with static mixing to eliminate gel, and then cooled to 60° C. for feeding into the particle-forming device.

The working volume of the particle-forming device, together with the mass flow of the mixture, will result in a mean cell residence time in the particle-forming apparatus under 20 sec. Combined with the residence time in the cell solution heat exchanger and the transfer line, the enzymatic cells will be subjected to elevated temperature for less than or equal to 1 min.

### Example 5

### Increase Viscosity of Temperature Sensitive Hydrogel Mixture by Introducing Quench Agent Prior to Exiting the Extrusion Die to Reduce Elongation of the Particles Due to Viscous Drag of the Quench Fluid

This Example is similar to Example 4 except that a third feed tank, a volumetric metering device, and a preheater will be added to permit feeding heated cationic quench fluid into a new third feed port on the particle-forming apparatus such that the hydrogel solution's viscosity will be increased. The higher viscosity of the resulting solution (e.g. carrageenan/hydrogel solution) will permit higher particle forming rates since particle deformation by viscous drag of the circulating quench fluid will be reduced. As a result, a carregeenan/biocatalyst mixture extrudate has a higher viscosity. In addition, it has reduced shape sensitivity to circulating quench fluid turbulence.

### Example 6

### Incorporating Hydroxyapatite into Carrageenan Beads Containing Yeast Cells for Ethanol Production Improves Ethanol Production Rate and Bead Integrity

Equipment and procedure are similar to Example 3 except that hydroxyapatite will be added to the carrageenan solution after the initial heating at a sufficient quantity so that the final beads contain 5 wt % hydroxyapatite. The cell suspension for this example will contain sufficient yeast suitable for ethanol production so that the final beads contain 0.5% dry weight yeast. The resulting particles will provide higher ethanol production rates than particles prepared without hydroxyapatite or free cells.

### Example 7

### Increasing Viscosity of Hydrogel Material by Using Internally Liberated Calcium Ions

This Example is similar to Example 1 except that the calcium source will be calcium citrate. The calcium citrate will be added using the second feed tank metering system and will be used to add 1.2 parts calcium citrate to 100 parts of a 2% alginate/0.5% dry yeast cell mixture that will be prepared in the first feed tank. A third feed tank and metering system will be required to meter 1 part D-glucono-1,5-lactone into the transfer line or the housing cavity of the particle-forming apparatus. The resulting particles will have improved gel strength relative to particles produced using an external calcium quench without impacting fermentation performance. The stronger particles will improve the rate of ethanol fermentation and therefore enable larger scale operation and improved separation of the ethanol from the microbes.

1. A hydrogel particle-forming apparatus comprising:
(a) a housing having a wall and a cavity,
(b) at least one inlet port in the wall of the housing for introducing hydrogel-forming suspension into the housing cavity,
(c) an extrusion die having a face with one or a plurality of extrusion holes through which the hydrogel-forming suspension can be extruded from the housing cavity,
(d) a cutting assembly comprising at least one cutting blade that cuts the hydrogel particle-forming suspension into individual hydrogel particles when the suspension exits the extrusion holes as the cutting blade moves across each extrusion hole, wherein the cutting blade is in close proximity with the face of the extrusion die and moves in a linear, rotating, or reciprocating manner,
(e) optionally, a drive shaft contained within the housing cavity,
(f) optionally, one or a plurality of bearings within the housing cavity supporting the drive shaft,
(g) optionally, one or a plurality of seals contacting the drive shaft,
(h) optionally a mixing device within the housing cavity for mixing the hydrogel-forming suspension,
(i) optionally, one or a plurality of radial slots in the housing cavity for distributing the hydrogel-forming suspension, and
(j) optionally, an internal pump within the housing cavity for moving the hydrogel-forming suspension to the extrusion die.

2. A hydrogel particle-forming system comprising:
(a) at least one feed station for containing a hydrogel-forming suspension,
(b) the hydrogel particle-forming apparatus of claim 1,
(c) a metering device having transfer lines connected to the feed station and to the hydrogel particle-forming apparatus for receiving hydrogel-forming suspension from the feed station and delivering it to the hydrogel particle-forming apparatus, and
(d) a quench station containing a quench fluid,
wherein the hydrogel particle-forming apparatus is at least partially submerged in the quench fluid and the hydrogel-forming suspension is extruded into the quench fluid from the hydrogel particle-forming apparatus to form hydrogel particles.

3. The system of claim 2 wherein the metering device is a volumetric metering pump.

4. The system of claim 2 wherein the cutting assembly is rotatably mounted and further comprises a plurality of mixing blades for mixing the quench fluid as the cutting assembly rotates in the quench fluid.

5. The system of claim 2 further comprising at least one mixing device for mixing components before they are introduced into the hydrogel particle-forming apparatus.

6. The system of claim 5 wherein the mixing device is located in the feed station.

7. The system of claim 5 wherein the mixing device is located in a transfer line of the metering device.

8. The system of claim 2 wherein the quench station further comprises an inclined surface for collecting the hydrogel particles and at least one additional collection reservoir for collecting the quench fluid as the quench fluid exits the quench station, wherein the quench fluid is recycled back from the additional collection reservoir into the quench station after the hydrogel particles are collected on the inclined surface.

9. The system of claim 2 further comprising at least one additional feed station for containing a quench fluid or an additive or both and a metering device having transfer lines connected to the additional feed station and to the hydrogel particle-forming apparatus for receiving the quench fluid or the additive from the additional feed station and delivering it to the hydrogel particle-forming apparatus.

10. The apparatus of claim 1 wherein the drive shaft is rotatably mounted in the housing cavity.

11. The system of claim 2 wherein the drive shaft is rotatably mounted in the housing cavity.

12. The apparatus of claim 1 wherein the mixing device within the housing cavity is driven by the drive shaft.

13. The system of claim 2 wherein the mixing device within the housing cavity is driven by the drive shaft.

14. The apparatus of claim 1 wherein the extrusion die contains a central opening and the drive shaft extends through the central opening of the extrusion die and wherein the cutting assembly is rotatably mounted on the drive shaft as it extends through the central opening.

15. The system of claim 2 wherein the extrusion die contains a central opening and the drive shaft extends through the central opening of the extrusion die and wherein the cutting assembly is rotatably mounted on the drive shaft as it extends through the central opening.

16. The apparatus of claim 1 wherein the mixing device within the housing cavity is driven by a rotatably mounted drive shaft and the extrusion die contains a central opening through which the drive shaft extends and wherein the cutting assembly is rotatably mounted on the drive shaft where it extends through the central opening.

17. The system of claim 2 wherein the mixing device within the housing cavity is driven by a rotatably mounted drive shaft and the extrusion die contains a central opening through which the drive shaft extends and wherein the cutting assembly is rotatably mounted on the drive shaft where it extends through the central opening.

18. The apparatus of claim 1 wherein the extrusion holes are uniformly spaced apart on the face of the extrusion die.

19. The system of claim 2 wherein the extrusion holes are uniformly spaced apart on the face of the extrusion die.

20. The apparatus of claim 1 wherein the extrusion holes are arranged in a circular array when the cutting assembly is rotatably mounted.

21. The apparatus of claim 1 wherein the extrusion holes have a generally circular cross-section.

22. The apparatus of claim 1 wherein the face of the extrusion die is treated with or is constructed from a material that has a high contact angle with the hydrogel-forming suspension, the material being selected from thermoplastic and thermoset polymers, mineral and glass reinforced polymers, ceramics, foams, minerals, oxides and metals.

23. The system of claim 2 wherein the face of the extrusion die is treated with or is constructed from a material that has a high contact angle with the hydrogel-forming suspension, the material being selected from thermoplastic and thermoset polymers, mineral and glass reinforced polymers, ceramics, foams, minerals, oxides and metals.

24. The apparatus of claim 1 wherein the extrusion die is constructed from an insulating material selected from thermoplastic and thermoset polymers, mineral and glass reinforced polymers, ceramics, foams, minerals, oxides and metals.

25. The system of claim 2 wherein the extrusion die is constructed from an insulating material selected from thermoplastic and thermoset polymers, mineral and glass reinforced polymers, ceramics, foams, minerals, oxides and metals.

26. The apparatus of claim 1 wherein the cutting assembly is selected from pitched turbines and flat turbines.

27. The system of claim 2 wherein the cutting assembly is selected from pitched turbines and flat turbines.

28. The apparatus of claim 1 wherein the internal pump within the housing cavity is a centrifugal, screw or volumetric displacement pump.

29. The system of claim 2 wherein the internal pump within the housing cavity is a centrifugal, screw or volumetric displacement pump.

30. The apparatus of claim 1 wherein the mixing device is selected from the group consisting of mechanical mixers and static mixers.

31. The system of claim 16 wherein the mixing device is selected from the group consisting of mechanical mixers.

32. The apparatus of claim 1 wherein the apparatus is heated by a heating device.

33. The system of claim 2 wherein at least one of the feed tank, the apparatus, the metering device, the quench station, or the system, independently, are heated by at least one heating device.

34. The apparatus of claim 32 wherein the heating device is selected from thermal mass heaters, traced systems, jacketed systems, and enclosures with circulating hot gases or liquids.

35. The system of claim 33 wherein the heating device is selected from thermal mass heaters, traced systems, jacketed systems, and enclosures with circulating hot gases or liquids.

36. The apparatus of claim 1 wherein the hydrogel-forming suspension comprises a hydrogel solution and a biocatalyst.

37. The system of claim 2 wherein the hydrogel-forming suspension comprises a hydrogel solution and a biocatalyst.

38. The apparatus of claim 36 wherein the biocatalyst is selected from the group consisting of whole cell suspensions, bacterial cells, fungi, algae, yeast cells, plant cells, animal cells, cellular organelles, purified or partially-purified enzyme preparations, and multi-enzyme complexes in appropriate buffer solutions.

39. The system of claim 37 wherein the biocatalyst is selected from the group consisting of whole cell suspensions, bacterial cells, fungi, algae, yeast cells, plant cells, animal cells, cellular organelles, purified or partially-purified enzyme preparations, and multi-enzyme complexes in appropriate buffer solutions.

40. A method for producing hydrogel particles, the method comprising the sequential steps of:
(a) providing a feed station containing a hydrogel-forming suspension,
(b) metering the hydrogel-forming suspension by a metering device having transfer lines connected to the feed station and receiving hydrogel material therefrom into the hydrogel particle-forming apparatus of claim 1, the apparatus being at least partially submerged in a quench fluid;
(c) extruding the hydrogel-forming suspension through the hydrogel particle-forming apparatus into the quench fluid; and
(d) cutting the extruded hydrogel-forming suspension by the hydrogel particle-forming apparatus into individual hydrogel particles.

41. The method of claim 40 wherein the hydrogel-forming suspension comprises a hydrogel solution and a biocatalyst.

42. The method of claim 41 wherein the biocatalyst is selected from the group consisting of whole cell suspensions, bacterial cells, fungi, algae, yeast cells, plant cells, animal cells, cellular organelles, purified or partially-purified enzyme preparations, and multi-enzyme complexes in appropriate buffer solutions.
